(19) United States
(12) Patent Application Publication
(10) Pub. No.: US 2026/0276108 A1
(43) Pub. Date: Sep. 17, 2026

(54) INSERTABLE COVER ASSEMBLY

(71) Applicant: Oldcastle Infrastructure, Inc., Atlanta, GA (US)

(72) Inventors: Hong Chen, Richmond (CA); Fariborz Joulani, Port Moody (CA); Kai Zhang, Abbotsford (CA); Jesse Hudgins, Paris, TN (US); David Brian Teague, Columbia, SC (US)

(21) Appl. No.: 19/337,459

(22) Filed: Sep. 23, 2025

Related U.S. Application Data
(60) Provisional application No. 63/772,534, filed on Mar. 15, 2025.

(51) Int. Cl. F16L 5/02; H02G 3/22

(52) U.S. Cl. CPC F16L 5/02; H02G 3/22

(57) ABSTRACT

A cover assembly is provided for temporarily or selectively sealing a wall structure opening and allowing passage of a conduit. The cover assembly comprises an outer wall and a barrier assembly and may comprise an attachment structure or a flange to secure the cover assembly in the opening. The outer wall comprises a length according to the thickness of the wall structure opening. The barrier assembly comprises a barrier and an inner wall that is disposed within the outer wall. The inner wall comprises a frustoconical shape that decreases distally within the hollow interior of the outer wall. The barrier comprises a plurality of adjacently disposed segments. Initially, the plurality of segments is adjacently disposed to one another and collectively define a closed position of the barrier. The plurality of segments expands by severing indentations therebetween to allow passage of the conduit with the barrier in an open position.

### CROSS REFERENCE TO RELATED APPLICATIONS

This application claims priority under 35 U.S.C. § 119(e) to U.S. Provisional Patent Application Ser. No. 63/772,534 filed on Mar. 15, 2025 and entitled “INSERTABLE COVER ASSEMBLY,” which is incorporated by reference herein in its entirety.

### FIELD

The present disclosure relates to cover assemblies for temporarily sealing openings in walls, and for providing a convenient structure to run conduits from one side of the wall to the other side of the wall through the openings.

### BACKGROUND

The background description includes information that may be useful in understanding the present disclosure. It is not an admission that any of the information provided herein is prior art or relevant to the present disclosure, or that any publication specifically or implicitly referenced is prior art.

Installation of utilities, including electrical, data, mechanical, and plumbing, is generally done after a substantial portion of a building has been constructed, including interior or exterior walls. Such utilities are also often installed in spaces that have already been constructed and need a renovation, retrofit or upgrade. Several buildings, warehouses, plants, facilities, depots, and installations require that utility lines go through interior or exterior walls. Often, utility lines need to go through walls of utility rooms, enclosures, or compartments of components and/or equipment of utility systems. As such, it becomes important to provide a solution for installation crews to efficiently pass utility lines, i.e., conduits, from one side of a wall to the other side of the wall after the wall is in place.

Frequently, the solution to these challenges involves creating an opening in a wall between two different spaces such that installation crews and technicians may use that opening in the future to install a utility line(s). However, this solution is associated with several drawbacks as this leaves the areas in question susceptible to environmental factors, including passage of moisture, dirt, debris, etc., between one side of the wall to the other side of the wall. Some areas of buildings, such as rooms, enclosures and/or compartments, are susceptible to such environmental factors. Accordingly, it is also important to take these considerations into account.

### SUMMARY

Embodiments of the present disclosure are directed to a cover assembly that seals an opening in a wall and that can be selectively modified to allow a conduit or other component to pass through the cover assembly and through the opening in the wall. The cover assembly can have a barrier that is selectively modified from a closed or sealed position to an open position where a conduit or other component may pass through. As described herein, the cover assembly has features that provide several benefits including reducing material usage, improving ease of use, improving safety, and reducing cost.

It is an aspect of embodiments of the present disclosure to provide a cover assembly with an outer wall and an inner wall to help guide any conduit or other component through the cover assembly and to provide material and cost savings. The outer wall can be substantially cylindrical in shape, or, stated differently, the outer wall has a constant diameter along a longitudinal axis of the cover assembly. However, it will be appreciated that the present disclosure encompasses embodiments where the outer wall has a non-constant diameter or a taper in a proximal or distal direction. The inner wall has a portion with a frustoconical shape that tapers toward a distal end of the cover assembly. At the end of the portion having the frustoconical shape is a barrier that can be selectively opened to permit a conduit or other component to pass through the cover assembly, and more broadly, through an opening in the wall. The frustoconical part of the inner wall channels the conduit or component into the barrier to prevent harmful or undesirable snags or impediments to the operation of the cover assembly.

It is another aspect of embodiments of the present disclosure to provide a space between the outer wall and the inner wall provides weight and material savings and also provides a lighter cover assembly, which helps with ease of installation in an opening of a wall. In some embodiments, a proximal end of the inner wall is joined to a proximal end of the outer wall. Then, as the outer and inner walls extend along the longitudinal axis in a distal direction, the outer and inner walls are joined at a plurality of reinforcement structures or ribs. These reinforcement ribs provide sufficient structural support to the outer and inner walls as well as the cover assembly more generally while also allowing for the space between the outer and inner walls to provide the weight and material savings.

In some embodiments, the cover assembly has five reinforcement ribs equally arrayed around the longitudinal axis. The number of five reinforcement ribs, or four to six reinforcement ribs, can be critical to provide sufficient structural support while minimizing weight and maximizing material savings in the form of space between the outer and inner walls. Moreover, once the barrier has been modified to allow a conduit or other component to pass through the barrier, five reinforcement ribs will ensure that at least two reinforcement ribs are bearing the weight of the conduit or other component and transferring that weight to the outer wall and then to the wall itself.

It is an aspect of embodiments of the present disclosure to provide a cover assembly with a barrier that has indentations to facilitate modification of the barrier to allow a conduit or other component to pass through the barrier and through the cover assembly. The indentations are parts of the barrier with a reduced thickness compared to non-indentation parts or segments defined between the indentations. These indentations can start at a center of the barrier and extend outward such that multiple indentations can share the common center of the barrier. These indentations can be apparent on one or both sides of the barrier. The indentations have a reduced thickness to allow a user to more easily and safely cut through the barrier. Once the indentations are cut, the segments can be pushed out of a plane that is normal to the longitudinal axis of the cover assembly, which then allows a conduit or other component to pass through the barrier and the cover assembly.

In some embodiments, the barrier has an even number of indentations to enhance ease of use and safety of a user. Specifically, with an even number, a user can cut two aligned indentations in a single motion. With half has many cutting motions, ease of use and the safety of the user is improved. In some embodiments, six indentations can represent a critical number of indentations that provides balance between creating a useful sized opening and segment arrangement through which to pass a conduit or other component versus number of cutting motions. In some embodiments, the one or more indentations can resemble known shapes, images, or symbols (i.e., an asterisk, shape, or brand logo/trademark).

It is a further aspect of embodiments of the present disclosure to provide a cover assembly with an attachment structure that secures the cover assembly within an opening of a wall. In some embodiments, the attachment structure comprises at least one rib that extends outwardly from an exterior surface of an outer wall of the cover assembly. In various embodiments, the at least one rib tapers or angles away from the direction of insertion. In other words, if the cover assembly is installed by moving the cover assembly in a distal direction, then the at least one rib tapers or angles in a proximal direction. As a result, the at least one rib provides little interference when the cover assembly is inserted into the opening of the wall. However, if a force acts on the cover assembly in the proximal direction to remove the cover assembly from the opening in the wall, then the at least one rib digs into the part of the wall that defines the opening and binds against that part of the wall. This helps secure the cover assembly in the opening of the wall. In some embodiments, it is contemplated that the present disclosure further includes an extendable, enlargeable, and/or installable portion of the cover assembly that further helps secure its position in the opening of the wall by creating a flange, or mechanically similar structure, on the opposite side of the wall.

In some embodiments, the cover assembly has a plurality of ribs to accommodate a variety of wall thicknesses. Not all walls have the same thickness, and it may be desirable to use the same cover assembly in different types of walls and applications. The cover assembly can have multiple ribs to ensure that at least one rib secures the cover assembly within an opening of the wall, even if the wall is thicker compared to other walls. In some embodiments, the cover assembly has four ribs, each with a different position along the longitudinal axis of the cover assembly. In various embodiments, the ribs can be offset from each other by equal and/or unequal distances along the longitudinal axis to accommodate different wall thicknesses.

In some embodiments, the cover assembly additionally or alternatively comprises, at least in part, a material composition allowing for selective enlargement or alteration of portions thereof in response to specific stimuli. In one example, the material is a type of polymer and the stimuli is an ultraviolet light that causes the polymer to enlarge or otherwise change shape. As a result, regions in the cover assembly can better fill gaps created when installing the cover assembly in an opening and/or support a conduit after being installed therethrough to prevent the intrusion of dirt, insects, etc.

A first aspect of the present disclosure is to provide a cover assembly for selective access through an opening of a wall structure and configured to permit an insertion of a conduit therethrough, the cover assembly comprising an outer wall comprising a substantially cylindrical shape, a length extending between a proximal end and a distal end of the outer wall, an exterior surface extending along the length of the outer wall, an attachment structure disposed on the exterior surface of the outer wall, the attachment structure configured to facilitate insertion and retention of the outer wall into the opening of wall structure, and an interior surface oppositely disposed to the exterior surface, and a barrier assembly comprising an inner wall with a hollow interior disposed on the interior surface of the outer wall around the proximal end and extending between a proximal end and a distal end of the inner wall, and a barrier disposed on the inner wall around the distal end of the inner wall, the barrier comprising a plurality of segments collectively defining a grommet configuration, the barrier disposable into and out of a closed position and an open position.

The cover assembly of the first aspect may include, optionally, a flange disposed at the proximal end of the outer wall and structured to prevent a further insertion of the outer wall into the wall structure beyond a predetermined position.

The cover assembly of the first aspect may include one or more of the previous embodiments and, optionally, that the flange comprises an opening disposed in fluid communication with the hollow interior of the inner wall.

The cover assembly of the first aspect may include one or more of the previous embodiments and, optionally, that the grommet configuration of the barrier is configured to expand as the conduit is passed through the barrier when the barrier is disposed in the open position.

The cover assembly of the first aspect may include one or more of the previous embodiments and, optionally, that the grommet configuration of the barrier is expanded to enable a fluid communication between the environment and the hollow interior of the inner wall when the barrier is disposed in the open position.

The cover assembly of the first aspect may include one or more of the previous embodiments and, optionally, that a diameter of the barrier is less than a diameter of the interior surface off the outer wall around the distal end of the outer wall.

The cover assembly of the first aspect may include one or more of the previous embodiments and, optionally, that the attachment structure comprises a plurality of adjacently disposed ribs disposed around a circumference of the outer wall.

The cover assembly of the first aspect may include one or more of the previous embodiments and, optionally, that each one of the plurality of adjacently disposed ribs comprises a different width than another adjacent one of the plurality of adjacently disposed ribs.

The cover assembly of the first aspect may include one or more of the previous embodiments and, optionally, that the attachment structure is disposed around a middle section of the outer wall.

The cover assembly of the first aspect may include one or more of the previous embodiments and, optionally, that the barrier assembly comprises a rubber material.

The cover assembly of the first aspect may include one or more of the previous embodiments and, optionally, that the segments comprise a material structured to at least partially reduce friction between the segments and the conduit.

The cover assembly of the first aspect may include one or more of the previous embodiments and, optionally, that the components or elements of the cover assembly are each composed of a polymer material, wherein each component or element is not required to be composed of the same polymer material.

The cover assembly of the first aspect may include one or more of the previous embodiments and, optionally, that the segments comprise a thermoplastic elastomer or a high-density polyurethane.

The cover assembly of the first aspect may include one or more of the previous embodiments and, optionally, that the outer wall and the barrier assembly are manufactured in a continuous mold injection process.

The cover assembly of the first aspect may include one or more of the previous embodiments and, optionally, that the opening of the wall structure is disposed in non-obstructing relation to a support of the wall structure.

The cover assembly of the first aspect may include one or more of the previous embodiments and, optionally, that the wall structure is part of an enclosure structure.

The cover assembly of the first aspect may include one or more of the previous embodiments and, optionally, that the inner wall comprises a frustoconical shape.

The cover assembly of the first aspect may include one or more of the previous embodiments and, optionally, that the segments of the barrier are adjacently disposed to one another and collectively define a substantially circular shape of the barrier when the barrier is disposed in the closed position.

The cover assembly of the first aspect may include one or more of the previous embodiments and, optionally, that the barrier further comprises a plurality of indentations between adjacently disposed segments.

A second aspect of the present disclosure is to provide a cover assembly manufactured according to a continuous mold injection process for insertion into an opening of a wall structure and configured to permit an insertion of a conduit therethrough, the cover assembly comprising an outer wall comprising a substantially cylindrical shape, a length extending between a proximal end and a distal end of the outer wall, an exterior surface extending along the length of the outer wall, an attachment structure disposed on the exterior surface of the outer wall around a middle section thereof, the attachment structure comprising a plurality of adjacently disposed ribs collectively structured to facilitate insertion and retention of the outer wall into the opening of wall structure, and an interior surface oppositely disposed to the exterior surface, a barrier assembly comprising an inner wall comprising a frustoconical shape with a hollow interior and disposed on the interior surface of the outer wall around the proximal end and extending to the proximal end of the outer wall, a barrier disposed on the inner wall around the proximal end, the barrier comprising substantially circular shape and a plurality of segments collectively defining a grommet configuration, the barrier disposable between a closed position and an open position, and the barrier configured to be expanded and enable a fluid communication between the environment and the hollow interior of the inner wall when the barrier is disposed in the open position, and a flange disposed around the proximal end of the outer wall and comprising an opening extending into the hollow interior of the inner wall.

A third aspect of the present disclosure is to provide a cover assembly for providing selective access through an opening, comprising an outer wall extending along an axis, the outer wall having an interior surface and an exterior surface; an attachment structure extending from the exterior surface of the outer wall, the attachment structure configured secure the cover assembly in the opening; an inner wall extending along the axis, wherein the inner wall extends from the interior surface of the outer wall at a proximal end to a barrier at a distal end; and a space between the interior surface of the outer wall and an exterior surface of the inner wall, wherein at least one reinforcement rib extends through the space and spans between the interior surface of the outer wall and the exterior surface of the inner wall; wherein the barrier is oriented in a plane, the barrier having a plurality of indentations that define a plurality of segments, wherein the plurality of indentations is configured to be severed to allow the plurality of segments to deflect out of the plane to permit a conduit or other component to extend through the inner wall and through the barrier.

The cover assembly of the third aspect may include, optionally, that the attachment structure is a plurality of ribs extending from the exterior surface of the outer wall.

The cover assembly of the third aspect may include one or more of the previous embodiments and, optionally, that each rib of the plurality of ribs tapers in a proximal direction of the cover assembly, and part of the inner wall tapers in an opposing distal direction of the cover assembly.

The cover assembly of the third aspect may include one or more of the previous embodiments and, optionally, that the at least one reinforcement rib comprises five reinforcement ribs arrayed evenly about the axis.

The cover assembly of the third aspect may include one or more of the previous embodiments and, optionally, that the plurality of indentations is an even number of indentations.

The cover assembly of the third aspect may include one or more of the previous embodiments and, optionally, that the even number of indentations is six.

The cover assembly of the third aspect may include one or more of the previous embodiments and, optionally, that a distal end of the outer wall lies in the plane of the barrier.

A fourth aspect of the present disclosure is to provide a method of using a cover assembly, comprising providing the cover assembly having a barrier oriented in a plane, the barrier having a plurality of indentations that define a plurality of segments; severing the plurality of indentations; pushing the plurality of segments out of the plane; and inserting a conduit through the barrier.

A fifth aspect of the present disclosure is to provide a cover assembly for selectively sealing an opening, comprising an outer wall extending from a proximal end to a distal end along a longitudinal axis; an inner wall extending from a proximal end to a distal end along the longitudinal axis, wherein a diameter of the distal end of the inner wall is smaller than a diameter of the distal end of the outer wall; a reinforcement structure spanning between the outer wall and the inner wall; an attachment feature extending from an exterior surface of the outer wall and configured to secure the cover assembly in the opening; and a barrier positioned at the distal end of the inner wall, wherein the barrier comprises at least one indentation configured to be severed to breach the seal and provide access through the barrier.

The cover assembly of the fifth aspect may include, optionally, that the inner wall tapers along the longitudinal axis from the proximal end of the inner wall to the distal end of the inner wall in a frustoconical shape.

The cover assembly of the fifth aspect may include one or more of the previous embodiments and, optionally, that the outer wall has a substantially constant diameter along the longitudinal axis from the proximal end of the outer wall to the distal end of the outer wall in a cylindrical shape.

The cover assembly of the fifth aspect may include one or more of the previous embodiments and, optionally, that the distal end of outer wall and the distal end of the inner wall are located at a common location on the longitudinal axis.

The cover assembly of the fifth aspect may include one or more of the previous embodiments and, optionally, a flange located at the proximal end of the outer wall, wherein the flange has a maximum diameter greater than a diameter of the outer wall at the proximal end to limit a position of the cover assembly in the opening, and the flange has an opening to provide access into a hollow interior defined by the inner wall.

The cover assembly of the fifth aspect may include one or more of the previous embodiments and, optionally, that the reinforcement structure comprises a plurality of ribs spanning between the outer wall and the inner wall.

The cover assembly of the fifth aspect may include one or more of the previous embodiments and, optionally, that the plurality of ribs comprises five ribs evenly arrayed about the longitudinal axis.

A sixth aspect of the present disclosure is to provide a cover assembly for selectively sealing an opening, comprising an outer wall extending from a proximal end to a distal end along a longitudinal axis; an inner wall extending from a proximal end to a distal end along the longitudinal axis, wherein the proximal end of the inner wall is joined to the proximal end of the outer wall; a flange located at the proximal end of the outer wall, wherein the flange has a maximum diameter greater than a diameter of the outer wall at the proximal end to limit a position of the cover assembly in the opening, and the flange has an opening to provide access into a hollow interior defined by the inner wall; an attachment feature extending from an exterior surface of the outer wall and configured to secure the cover assembly in the opening; and a barrier positioned at the distal end of the inner wall, wherein the barrier comprises at least one indentation configured to be severed to breach the seal and provide access through the barrier.

The cover assembly of the sixth aspect may include, optionally, that the flange has at least one rounded portion and at least one straight portion, and wherein the at least one rounded portion defines the maximum diameter of the flange.

The cover assembly of the sixth aspect may include one or more of the previous embodiments and, optionally, that the attachment feature is a plurality of ribs spaced along the longitudinal axis.

The cover assembly of the sixth aspect may include one or more of the previous embodiments and, optionally, that two adjacent ribs of the plurality of ribs are spaced by a first distance and another two adjacent ribs of the plurality of ribs are spaced by a second distance that is distinct from the first distance.

The cover assembly of the sixth aspect may include one or more of the previous embodiments and, optionally, that each rib of the plurality of ribs tapers outwardly such that a tip of each rib is closer to the proximal end of the outer wall than a base of each rib to secure the cover assembly in the opening.

The cover assembly of the sixth aspect may include one or more of the previous embodiments and, optionally, that the outer wall, the inner wall, the flange, the attachment feature, and the barrier are a continuous structure made of a material.

The cover assembly of the sixth aspect may include one or more of the previous embodiments and, optionally, that the material is one of a thermoplastic elastomer or a high density polyurethane.

A seventh aspect of the present disclosure is to provide a cover assembly for selectively sealing an opening, comprising an outer wall extending from a proximal end to a distal end along a longitudinal axis; an inner wall extending from a proximal end to a distal end along the longitudinal axis, wherein the proximal end of the inner wall is joined to the proximal end of the outer wall; an attachment feature extending from an exterior surface of the outer wall and configured to secure the cover assembly in the opening; and a barrier positioned at the distal end of the inner wall, and the distal end of the outer wall lies in a plane of the barrier, wherein the barrier has a thickness, and the barrier comprises at least one indentation of reduced thickness, wherein the at least one indentation is configured to be severed to breach the seal and provide access through the barrier.

The cover assembly of the seventh aspect may include, optionally, that the at least one indentation is an even number of indentations with each indentation extending from a center of the barrier toward an outer edge of the barrier.

The cover assembly of the seventh aspect may include one or more of the previous embodiments and, optionally, that the even number of indentations is six indentations evenly arrayed about the longitudinal axis.

The cover assembly of the seventh aspect may include one or more of the previous embodiments and, optionally, that each indentation is aligned with another indentation to make the indentations severable in a single stroke.

The cover assembly of the seventh aspect may include one or more of the previous embodiments and, optionally, a reinforcement structure spanning between the outer wall and the inner wall, wherein a diameter of the distal end of the inner wall is smaller than a diameter of the distal end of the outer wall.

The cover assembly of the seventh aspect may include one or more of the previous embodiments and, optionally, a flange located at the proximal end of the outer wall, wherein the flange has a maximum diameter greater than a diameter of the outer wall at the proximal end to limit a position of the cover assembly in the opening, and the flange has an opening to provide access into a hollow interior defined by the inner wall.

The phrases “at least one”, “one or more”, and “and/or”, as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about” or “approximately”. As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves. Moreover, any Appendixes enclosed herein are incorporated herein in their entireties.

These and other advantages will be apparent from the disclosure of the invention(s) contained herein. The above-described embodiments, objectives, and configurations are neither complete nor exhaustive. The Summary is neither intended nor should it be construed as being representative of the full extent and scope of the present disclosure. Moreover, references made herein to “the present disclosure” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1A is a perspective rear view a cover assembly according to the present disclosure.

FIG. 1B is a perspective rear view of a cover assembly according to the present disclosure.

FIG. 2 is a side view of a cover assembly according to the present disclosure.

FIG. 3A is a perspective front view of a cover assembly according to the present disclosure.

FIG. 3B is a perspective front view of a cover assembly according to the present disclosure.

FIG. 4 is a perspective view of a wall enclosure with two cover assemblies according to the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure. It will be appreciated that recitation of, for example, reference character 116, 116A, 116B, etc. may apply to any combination of reference characters 116, 116A, 116B, etc.
10 Cover Assembly
12 Proximal End (Outer Wall)
14 Distal End (Outer Wall)
16 Opening
18 Length(Cover Assembly)
20 Outer Wall
21 Length(Outer Wall)
22 Exterior Surface
23 Exterior Diameter
24 Interior Surface
25 Interior Diameter
26 Proximal Section
28 Middle Section
30 Attachment Feature
31 Ribs
32 Distal Section
33a Base (Rib)
33b Tip (Rib)
34 Longitudinal Axis
36 Distal Direction
38 Proximal Direction
40 Hollow Interior
50 Barrier Assembly
52 Inner Wall
53 Proximal End (Inner Wall)
54 Reinforcement Structure
55 Distal End (Inner Wall)
56 Barrier
58 Diameter
60 Segments
62 Indentations
70 Flange
72 Rounded Portions
74 Straight Portions
76 Enclosure
78 Wall
80 Support
82 Opening

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment of the cover assembly since describing every possible embodiment would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the cover assembly can be combined with dimensions, aspects, and features of another embodiment of the cover assembly to create the claimed embodiment.

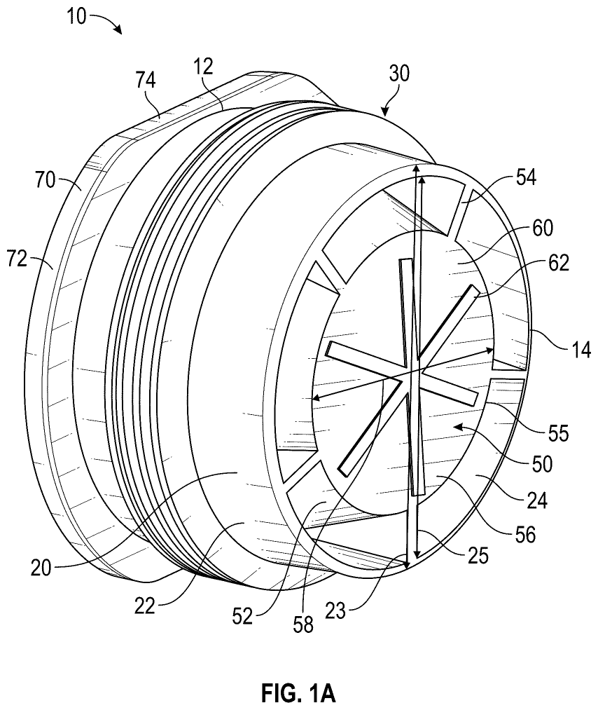

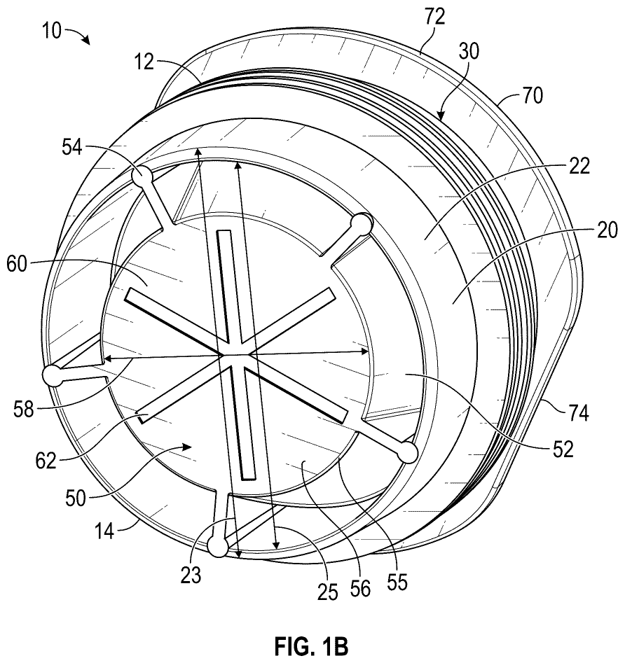

With reference to FIGS. 1A-4, embodiments according to the present disclosure are directed to a cover assembly 10 for insertion into an opening of a wall structure. The cover assembly 10 serves as a seal that can be modified to allow an efficient insertion and/or passing of a conduit from one side of the wall structure to the other side. As used herein, the term “conduit” refers to any one or more utility structures, including without limitation, electrical, mechanical, plumbing, data, communications, which may implement a wire, including electrical a cable or wire such as data wires, tracer wires, as well as pipes, conduits, connections, cords, links, or other related components. As contemplated by embodiments according to the present disclosure, such conduits may be color coded for identification and/or installation purposes. By way of example, a coloring scheme may be implemented comprising black for fiber optic, blue for coax, and/or purple for electrical. As a further example, a coloring scheme may be implemented according to differentiate different conduits associated with different service providers. It will be appreciated that the present disclosure encompasses any structure or component that passes through a wall structure or that otherwise can benefit from the cover assembly 10.

As used herein, a “wall structure” generally refers to an exterior or interior wall of a building, including a partition wall, structural or load bearing wall, non-load bearing wall, shear walls, cavity walls, retaining walls and other types of walls. A “wall structure” further refers to a wall of an enclosure, for example to house and/or protect equipment and components of utilities, including electrical, communications, data, internet, mechanical, plumbing, fire protection, etc. In embodiments according to the present disclosure, the term “wall structure” refers to a wall or portion thereof that is made of any one or more of a variety of materials, including without limitation resins, concrete, including polymer concrete, cement, glass, architectural tiles, plastics, metals, bricks, wood, stone, synthetic materials such as gypsum board, PVC, composites, and combinations thereof. Embodiments according to the present disclosure further contemplate that the cover assembly 10 be used to seal an opening disposed on the wall structure that may be used as an entry point for a utility conduit or line. In embodiments, the opening(s) on the wall structure is disposed at an intended location, which is generally a location within the wall structure that does not obstruct other architectural or functional components associated with the wall structure, including structural components such as framing components, e.g., metal or wood studs, structural reinforming, e.g., rebar, existing conduits, etc. It will be appreciated that the present disclosure encompasses any structure that receives a conduit or otherwise benefits from the cover assembly 10.

In embodiments according to the present disclosure, the opening of the wall structure is generally intended to allow a utility line, connection or conduit to pass from one side of the wall structure to the other. The cover assembly 10, including a barrier assembly 50, is generally intended to be a temporary weather-resistant boundary or obstruction that protects from environmental factors before installation of the conduit(s). That is, in embodiments the cover assembly 10 is configured to at least partially reduce passage and/or ingress of moisture, dust and/or other debris, through the wall structure before installation of a utility conduit or connection. The cover assembly 10, including the barrier assembly 50 is also generally intended to act as temporary and/or removable seal on the opening of the wall structure that allows for installation crews or technicians to efficiently pass the conduit, e.g., jacket of a cable, piping, etc., from one side of the wall structure to the other.

In embodiments, the cover assembly 10 according to the present disclosure is intended to not only act as a seal to the opening of the wall structure, but also to reduce contact friction when the conduit(s) is being passed through the cover assembly 10 and the opening of the wall structure. Accordingly, and as will be explained in more detail, in embodiments the barrier assembly 50 and/or other components of the cover assembly 10 are provided with a polymer, such as a soft rubber material, structured to maintain the integrity of the conduit when it is passed through the cover assembly 10. As contemplated herein, such a material creates a smooth lining that reduces the likelihood of snags and/or tears as the conduit, e.g., jacket of cable, is passed through the cover assembly 10.

As shown in the illustrative embodiments of FIGS. 1A-3B, the cover assembly 10 generally comprises an outer wall 20 that is intended for insertion into the opening of the wall structure. As contemplated by the present disclosure, the cover assembly 10 may be inserted into the opening of the wall structure to act as a temporary protection seal, but that may act as a permanent building fixture once a conduit is installed or passed through the cover assembly 10, or even if the cover assembly 10 is never modified and never used to accommodate a conduit or other structure. However, other embodiments contemplate that the cover assembly 10 may be initially used in one location and later removed and used in another location. In some embodiments, the outer wall 20 comprises a substantially cylindrical shape that extends along a length 21 thereof. However, it will be appreciated that the present disclosure encompasses embodiments where the outer wall 20 may comprise a different shape, for example, a cross section that is elliptical, square, rectangular, polygonal, hexagonal, heptagonal, octagonal, etc. The length 21 of the outer wall 20 may be adjusted according to the thickness of the wall structure and or opening thereof. In embodiments, the length 21 of the outer wall 20 is approximately equal to the thickness of the wall structure and/or opening thereof. In other embodiments, the length 21 of the outer wall 20 is less than the thickness of the wall structure and/or opening thereof. In further embodiments, the length 21 of the outer wall 20 is greater than the thickness of the wall structure and/or opening thereof so that the cover assembly 10 can function with a variety of wall thicknesses.

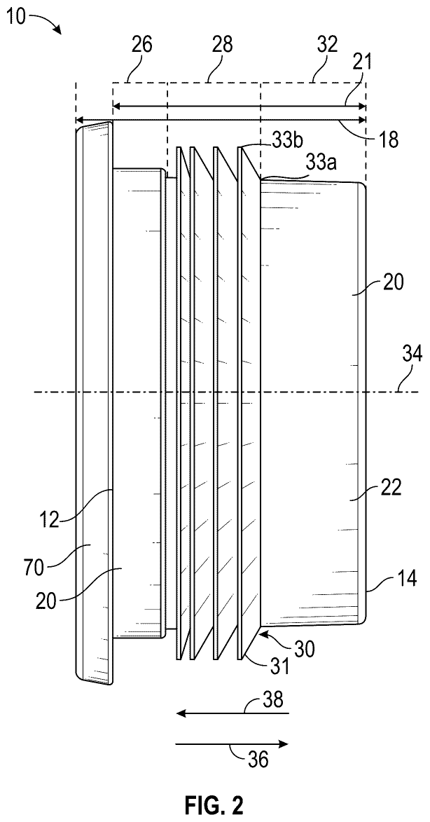

In embodiments, the outer wall 20 comprises three different sections, namely a proximal section 26, a middle section 28 and a distal section 32. In some embodiments, for example as shown in FIG. 2, the proximal section 26 comprises a size and/or diameter that is at least greater than that of the middle section 28, minus an attachment feature 30, and/or distal section 32. As is shown in FIGS. 1A-1B, in embodiments the outer wall 20 generally comprises an exterior diameter 23 and an interior diameter 25 that defines a thickness of the outer wall 20. These diameters 23, 25 can be substantially constant along a longitudinal axis 34 or even taper in a distal direction 36 or proximal direction 38.

As is shown in FIGS. 1A-2, in embodiments the cover assembly 10 generally comprises a middle section 28 with an attachment feature 30. In one or more embodiments, an attachment feature 30 is disposed around the circumference of the outer wall 20, for example around an exterior surface 22 of the outer wall 20. Generally, the attachment feature 30 is configured to permit an efficient insertion and/or retention of the outer wall 20 into the opening of the wall structure. As shown in FIG. 2, in some embodiments the attachment feature 30 comprises a plurality of adjacently disposed ribs 31. In embodiments, the ribs 31 of the attachment feature 30 extend outwardly from the middle section 28 and are tapered or otherwise inclined against movement in the distal direction 36 along the longitudinal axis 34. Said differently, in such embodiments, the ribs 31 of the attachment feature 30 are oriented along direction 38 to facilitate insertion of the outer wall 20 into the wall opening. Further still, the base 33a of a given rib 31a is closer to the distal end 14 of the outer wall 20, and a tip 33b is closer to a proximal end 12 of the outer wall 20.

Additionally, once the outer wall 20 has been inserted into the wall opening, the orientation of the ribs 31 of the attachment feature 30 creates a frictional resistance with the wall structure such that the outer wall 20 can remain in place unless a force in direction 38 exceeds such frictional resistance. In embodiments, a plurality of adjacently disposed ribs 31 of the attachment feature 30 is configured to accommodate openings of different sizes and/or wall structure thicknesses. In various embodiments, individual ones of the plurality of ribs 31 of the attachment feature 30 comprise different widths to accommodate openings of different sizes. However, it will be appreciated that the present disclosure encompasses embodiments where the attachment feature 30 may comprise other attachment mechanisms.

With reference again to FIGS. 1A-3B, embodiments of the cover assembly 10 according to the present disclosure generally comprise a flange 70 structured to prevent an axial movement of the outer wall 20 within the opening of the wall structure beyond a predetermined distance. In embodiments the flange 70 is also structured to prevent the outer wall 20 from otherwise falling from the wall structure. With reference to FIG. 2, embodiments according to the present disclosure contemplate that the outer wall 20 be inserted into the opening of the wall structure in distal direction, i.e., in direction 36 and along the longitudinal axis 34 defined along the length of the outer wall 20. In one or more embodiments according to the present disclosure, a flange 70 is disposed at the proximal end 12 of the outer wall 20.

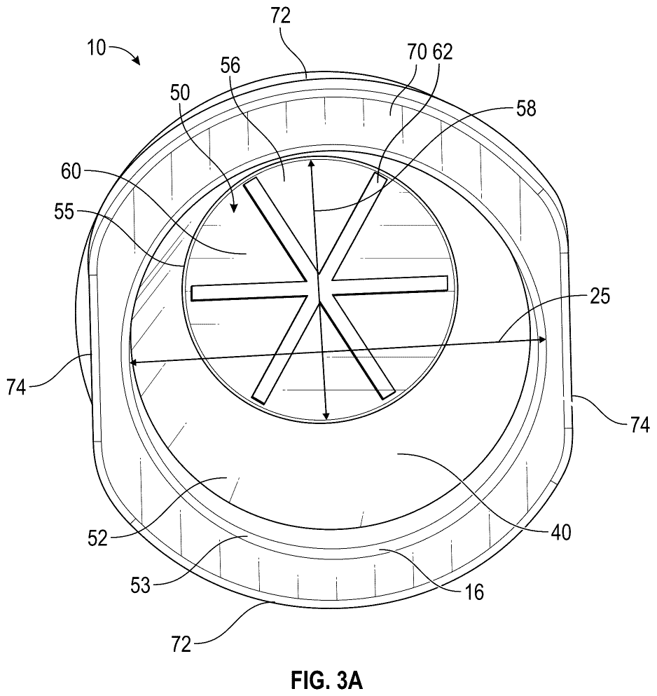

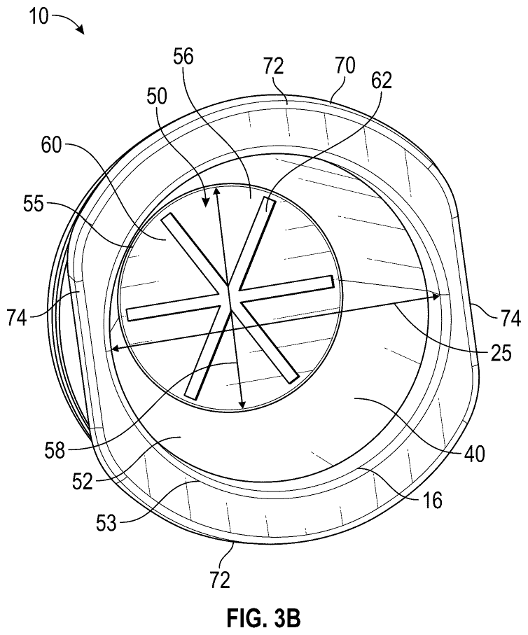

As may be appreciated in FIGS. 3A-3B, in embodiments an opening 16 is disposed on the flange 70. In such embodiments, the opening 16 is disposed in fluid communication with a hollow interior 40 of the inner wall 52. In one or more embodiments, the opening 16 comprises a size or diameter that is at least approximately 2″ to receive conduits of standard industry sizes. However, it will be appreciated that the present disclosure encompasses embodiments where other sizes of the opening 16 and/or hollow interior 40 of the inner wall 52 are also contemplated to accommodate conduits of other sizes or diameters. As such, as is also shown in FIG. 2, the flange 70 and the outer wall 20 may collectively define a combined length 18 of the cover assembly 10.

As is shown in FIGS. 1A-2, in embodiments, the flange 70 comprises a diameter that is at least greater than the diameter of the opening 16 and/or interior diameter 25 of the inner wall 52. Moreover, the flange 70 has a maximum diameter greater than a diameter of the outer wall 20. As such, the flange 70 may act as a structure that acts as a stopper once the outer wall 20 has been inserted into the opening of the wall structure, i.e., once the flange 70 contacts the portion of the wall structure surrounding the opening of the wall structure. As such, in addition to the outer wall 20 and/or barrier assembly 50, the flange 70 also serves as a protective lining to the opening of the wall structure, limiting passage of moisture, debris, dust, etc.

As is shown in FIGS. 3A-3B, in embodiments the flange 70 comprises rounded portions 72 and/or straight portions 74. The straight portions 74 are optional but provide an advantage as they reduce the reach or extension of the flange 70 around the wall structure and adjacent to the opening when compared to the rounded portions 72 or other configurations of the flange 70. The straight portions 74 or side cuts are advantageous where there is insufficient space to avoid other existing structures, for example, wall supports, reinforcement structures, existing conduits, etc.

With reference to FIGS. 1A-3B, and as mentioned herein, embodiments according to the present disclosure contemplate providing a cover assembly 10 with a barrier assembly 50. As contemplated in embodiments according to the present disclosure, the barrier assembly 50 is intended to cover or otherwise act as a temporary seal to the opening of the wall structure. As is shown in FIGS. 1A and 1B, in one or more embodiments the barrier assembly 50 comprises the inner wall 52 and a barrier 56. The inner wall 52 is generally connected to the interior surface 24 of the outer wall 20, for example, at a proximal end 12 and/or at reinforcement structures 54 such as ribs. However, it will be appreciated that the present disclosure encompasses embodiments where the inner wall 52 may be connected to the outer wall 20 at other locations on the proximal section 26, the middle section 28 and/or the distal section 32. As is shown in FIGS. 1A-3B, the barrier 56 is connected to the inner wall 52, and the barrier 56 has a diameter 58 that is less than the diameters 23, 25 associated with the outer wall 20.

In embodiments, the inner wall 52 comprises a frustoconical shape, i.e., a tapered configuration that distally decreases in diameter from a proximal end 53 to a distal end 55. In embodiments according to the present disclosure, the location of the barrier 56 is substantially coincident with a plane defined at the distal end 55 of the inner wall 52. In embodiments, the location of the barrier 56 is substantially coincident with a plane that is substantially transverse or normal to the longitudinal axis 34. In embodiments, the proximal end 53 of the inner wall 52 is substantially coincident with the proximal end 12 of the outer wall 20. Accordingly, in such embodiments, for example as shown in FIGS. 1A and 1B, the location of the barrier 56 is substantially coincident with a plane defined at both the distal end 14 of the outer wall 20 and the distal end 55 of the inner wall 52. In embodiments, the distal end 55 of the inner wall 52 is substantially coincident with the distal end 14 of the outer wall 20. However, it will be appreciated that the present disclosure encompasses embodiments where the distal end 55 of the inner wall 52 only extends to other locations within the distal section 32 or the middle section 28 of the outer wall 20 or even beyond. In other embodiments, the location of the barrier 56 is not coincident with a plane defined at the distal end 14 of the outer wall 20. In such embodiments, the barrier 56 is coincident with a plane that is transverse or normal to the longitudinal axis 34 around other locations of the distal section 32 or middle section 28.

With further reference to FIGS. 1A and 1B, in some embodiments the barrier assembly 50 comprises a plurality of reinforcement structures 54. In such embodiments, the reinforcement structures 54 are disposed between the interior surface 24 of the outer wall 20 and the inner wall 52. Generally, the reinforcement structures 54 are configured to maintain a desired position or spacing of the inner wall 52 relative to the outer wall 20 as well as to support the frustoconical shape of the inner wall 52. In embodiments, the reinforcement structures 54 are configured to increase the sealing capabilities of the cover assembly 10 while securely maintaining the barrier in an intended position. As shown in FIGS. 1A and 1B, in embodiments, the reinforcement structures 54 comprise a plurality of ribs disposed in a spaced apart relation to one another between the interior surface 24 of the outer wall 20 and the inner wall 52. In embodiments, the reinforcement structures 54 are configured to act as a bridge in the otherwise void or empty space between the inner wall 52 and the outer wall 20. In one or more embodiments, the reinforcement structures 54 comprise three, four, five or more equidistantly disposed reinforcement structures. For example, the illustrative embodiment of FIGS. 1A and 1B shows a cover assembly 10 with five reinforcement structures 54, which are ribs in this embodiment. Four or more reinforcement structures 54 are advantageous to provide support below the conduit that will pass through the barrier 56, which will be explained below.

As is shown in FIGS. 1A-3B, and as mentioned above the barrier assembly 50 comprises a barrier 56 disposed on the distal end 55 of the inner wall 52. The barrier 56 generally comprises a plurality of segments 60 that collectively define a shape of the barrier 56. As contemplated by the present disclosure, the shape of the barrier 56 is generally structured to correspond to the shape of the inner wall 52 at its distal end 55 to promote the travel of a conduit through the cover assembly, once the barrier 56 is opened. Accordingly, in embodiments both the inner wall 52 at the distal end and the barrier 56 comprise a circular shape. However, it will be appreciated that the present disclosure encompasses embodiments whereas other shapes are also contemplated, for example, semi-circular, ovoidal, polygonal, etc.

As is shown in the illustrative embodiment of FIGS. 1A and 1B, the plurality of segments 60 are generally separated by a plurality of delineations, indentations, scores, or other parts of the barrier 56 with reduced wall thickness, which are indicated at 62. In embodiments, the plurality of indentations 62 comprise indentations configured to facilitate breaking or tearing them either by cutting, e.g., with a blade, or by inserting and/or forcing a conduit through the interior wall and/or through the barrier 56. In other embodiments, the indentations 62 are pre-cut. In one or more embodiments, the indentations 62 are formed along with other components of the cover assembly 10, in a continuous injection molding process. In embodiments, the indentations 62 are formed to have a thinner thickness than the segments 60 such that they can be cut or broken with relative ease. As such, embodiments according to the present disclosure contemplate that individual segments 60 be able to reciprocally move along the longitudinal axis 34 about their attachment to the outer wall 20 and create an opening that allows a conduit to pass therethrough. Accordingly, in embodiments the barrier 56 comprises a material configured to allow a reciprocal movement of the segments 60 along the longitudinal axis 34. In embodiments, the segments 60 comprise a material structured to at least partially reduce friction between the segments 60 and conduit as it is being inserted though the barrier 56, including to create a smooth lining that reduces the likelihood of snags and/or tears of the conduit. In embodiments, the segments 60 comprise a thermoplastic elastomer (TPE).

As is seen in the illustrative embodiments of FIGS. 1A-3B, the indentations 62 start at a center of the barrier 56 and then extend outward toward an edge of the barrier 56. For example, the barrier 56 as shown in the illustrative embodiment of FIGS. 1A-3B comprises six indentations 62 extending in a radial direction of the barrier 56 to divide the barrier 56 into six different segments 60. In the illustrative embodiment of FIGS. 1A and 1B, five reinforcement structures 54 provide support to the six segments 60 of the barrier 56. In embodiments, the number of indentations 62 is a multiple of two so that multiple indentations 62 can be cut in a single motion. In various embodiments, the two indentations 62 are aligned to promote the cutting or severing of multiple indentations 62 in a single motion. As shown in the illustrative embodiments of FIGS. 1A-1B and 3A-3B, the six indentations 62 are aligned in three pairs of two, such that all six indentations could be severed in three motions. Moreover, in some embodiments the segments 60 comprise a substantially triangular shape with an arched edge that is disposed against the inner wall 52. However, it will be appreciated that the present disclosure encompasses embodiments where other shapes of the segments 60 and/or configurations of the indentations 62 are also possible. In at least one embodiment, a cover assembly 10 may be provided without a barrier 56 to further reduce contact friction with the conduit.

In embodiments according to the present disclosure, the cover assembly 10 is manufactured according to a mold injection process. In embodiments, one or more of the segments 60 comprise a material configured to maintain dimensional tolerances during an injection molding manufacturing process, such as for example, a thermoplastic elastomer (TPE) or a high-density polyurethane. In some embodiments, the outer wall 20 and the barrier assembly 50 are manufactured according to an injection molding manufacturing process. In some embodiments, the outer wall 20, the barrier assembly 50 and the flange 70 are manufactured according to an injection molding manufacturing process. In various embodiments, all components of the cover assembly 10 are made by injection molding, and therefore, form a single continuous structure.

Additional features of the present disclosure comprise providing a cover assembly 10 with a barrier 56 is disposable between a closed position and an open position. As shown in FIGS. 1A-3B, embodiments according to the present disclosure contemplate providing a cover assembly 10 with a barrier 56 that is initially provided in a closed position. As seen in FIGS. 1A-3B, in the closed position, the segments 60 are adjacently disposed to one another and collectively define a closed end of the inner wall 52. In the closed position, the segments 60 are aligned with a plane that is transverse or normal to the longitudinal axis 34. Conversely, in embodiments the segments 60 are at least partially bent or otherwise deformed along direction 36 and define an opening of the barrier 56 that enables a fluid communication between the hollow interior 40 of the inner wall 52 and the exterior when the barrier 56 is disposed in the open position. Said differently, the barrier 56 is expanded outward from the center of the barrier 56 along direction 36 to enable a fluid communication between the hollow interior 40 of the inner wall 52 and the exterior when the barrier 56 is disposed in the open position. In embodiments, the segments 60 of the barrier 56 expand according to the size and/or orientation of the conduit passing therethrough. In one or more embodiments, the barrier 56 is structured to expand as a conduit is passed through the barrier when the barrier 56 is disposed in the open position.

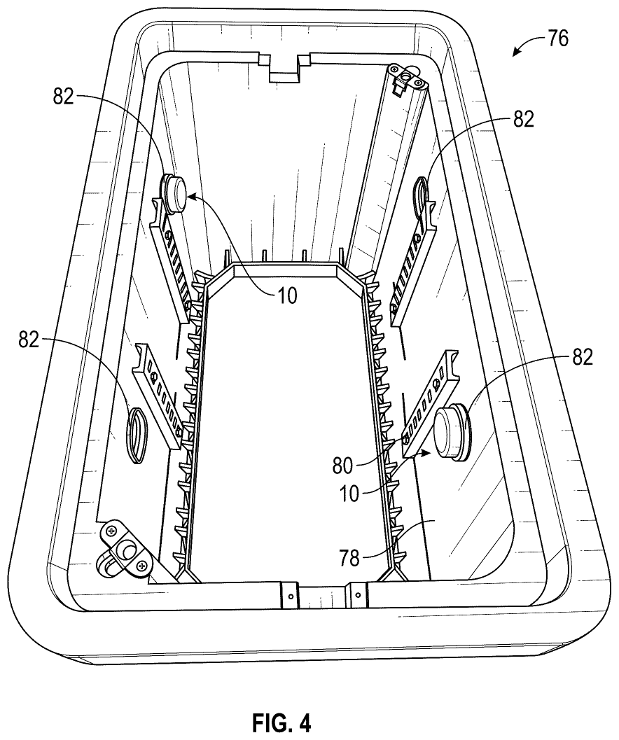

FIG. 4 shows a perspective view of an enclosure 76 with four openings 82 through sidewalls 78 of the enclosure 76. Here, two cover assemblies 10 are depicted in respective openings 82. The cover assemblies 10 can be installed in the openings 82 by securely pressing the cover assembly 10 into the opening 82 such that the attachment feature (30 in FIG. 2) of the cover assembly 10 binds against the part of the wall 78 that defines the opening 82. Supports 80 can be included in the enclosure 76 to support utilities or trays, or other components.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A cover assembly for selectively sealing an opening, comprising:
an outer wall extending from a proximal end to a distal end along a longitudinal axis;
an inner wall extending from a proximal end to a distal end along the longitudinal axis, wherein a diameter of the distal end of the inner wall is smaller than a diameter of the distal end of the outer wall;
a reinforcement structure spanning between the outer wall and the inner wall;
an attachment feature extending from an exterior surface of the outer wall and configured to secure the cover assembly in the opening; and
a barrier positioned at the distal end of the inner wall, wherein the barrier comprises at least one indentation configured to be severed to breach the seal and provide access through the barrier.

2. The cover assembly of claim 1, wherein the inner wall tapers along the longitudinal axis from the proximal end of the inner wall to the distal end of the inner wall in a frustoconical shape.

3. The cover assembly of claim 1, wherein the outer wall has a substantially constant diameter along the longitudinal axis from the proximal end of the outer wall to the distal end of the outer wall in a cylindrical shape.

4. The cover assembly of claim 1, wherein the distal end of outer wall and the distal end of the inner wall are located at a common location on the longitudinal axis.

5. The cover assembly of claim 1, further comprising a flange located at the proximal end of the outer wall, wherein the flange has a maximum diameter greater than a diameter of the outer wall at the proximal end to limit a position of the cover assembly in the opening, and the flange has an opening to provide access into a hollow interior defined by the inner wall.

6. The cover assembly of claim 1, wherein the reinforcement structure comprises a plurality of ribs spanning between the outer wall and the inner wall.

7. The cover assembly of claim 6, wherein the plurality of ribs comprises five ribs evenly arrayed about the longitudinal axis.

8. A cover assembly for selectively sealing an opening, comprising:
an outer wall extending from a proximal end to a distal end along a longitudinal axis;
an inner wall extending from a proximal end to a distal end along the longitudinal axis, wherein the proximal end of the inner wall is joined to the proximal end of the outer wall;
a flange located at the proximal end of the outer wall, wherein the flange has a maximum diameter greater than a diameter of the outer wall at the proximal end to limit a position of the cover assembly in the opening, and the flange has an opening to provide access into a hollow interior defined by the inner wall;
an attachment feature extending from an exterior surface of the outer wall and configured to secure the cover assembly in the opening; and
a barrier positioned at the distal end of the inner wall, wherein the barrier comprises at least one indentation configured to be severed to breach the seal and provide access through the barrier.

9. The cover assembly of claim 8, wherein the flange has at least one rounded portion and at least one straight portion, and wherein the at least one rounded portion defines the maximum diameter of the flange.

10. The cover assembly of claim 8, wherein the attachment feature is a plurality of ribs spaced along the longitudinal axis.

11. The cover assembly of claim 10, wherein two adjacent ribs of the plurality of ribs are spaced by a first distance and another two adjacent ribs of the plurality of ribs are spaced by a second distance that is distinct from the first distance.

12. The cover assembly of claim 10, wherein each rib of the plurality of ribs tapers outwardly such that a tip of each rib is closer to the proximal end of the outer wall than a base of each rib to secure the cover assembly in the opening.

13. The cover assembly of claim 8, wherein the outer wall, the inner wall, the flange, the attachment feature, and the barrier are a continuous structure made of a material.

14. The cover assembly of claim 13, wherein the material is one of a thermoplastic elastomer or a high density polyurethane.

15. A cover assembly for selectively sealing an opening, comprising:
an outer wall extending from a proximal end to a distal end along a longitudinal axis;
an inner wall extending from a proximal end to a distal end along the longitudinal axis, wherein the proximal end of the inner wall is joined to the proximal end of the outer wall;
an attachment feature extending from an exterior surface of the outer wall and configured to secure the cover assembly in the opening; and
a barrier positioned at the distal end of the inner wall, and the distal end of the outer wall lies in a plane of the barrier, wherein the barrier has a thickness, and the barrier comprises at least one indentation of reduced thickness, wherein the at least one indentation is configured to be severed to breach the seal and provide access through the barrier.

16. The cover assembly of claim 15, wherein the at least one indentation is an even number of indentations with each indentation extending from a center of the barrier toward an outer edge of the barrier.

17. The cover assembly of claim 15, wherein the even number of indentations is six indentations evenly arrayed about the longitudinal axis.

18. The cover assembly of claim 15, wherein each indentation is aligned with another indentation to make the indentations severable in a single stroke.

19. The cover assembly of claim 15, further comprising a reinforcement structure spanning between the outer wall and the inner wall, wherein a diameter of the distal end of the inner wall is smaller than a diameter of the distal end of the outer wall.

20. The cover assembly of claim 15, further comprising a flange located at the proximal end of the outer wall, wherein the flange has a maximum diameter greater than a diameter of the outer wall at the proximal end to limit a position of the cover assembly in the opening, and the flange has an opening to provide access into a hollow interior defined by the inner wall.
